(19) United States
(12) Patent Application Publication
(10) Pub. No.: US 2008/0202484 A1
(43) Pub. Date: Aug. 28, 2008

(54) Ignition coil for an internal combustion engine

(76) Inventors: Alfred Glatz, Sonthofen (DE); Konstantin Lindenthal, Blaichach (DE); Nikolaus Hautmann, Weitnau (DE); Markus Knepper, Waltenhofen/Oberdorf (DE)

Correspondence Address: KENYON & KENYON LLP, ONE BROADWAY, NEW YORK, NY, 10004, US

(21) Appl. No.: 11/540,130

(22) Filed: Sep. 29, 2006

(30) Foreign Application Priority Data
Sep. 30, 2005 (DE) 102005047185.4

(51) Int. Cl. H01F 38/12

(52) U.S. Cl. 123/634

(57) ABSTRACT

An ignition coil for an internal combustion engine has a core, which is provided with a plastic extrusion coat on its periphery. The core is concentrically surrounded by a secondary coil and a primary coil. The plastic extrusion coat of the core is used as a coil shell for the secondary coil so that it is possible to dispense with a separate secondary coil shell. The ignition coil therefore has an especially compact design.

### BACKGROUND INFORMATION

An ignition coil is described in German Patent Application No. DE 10 2004 039 109. In the known ignition coil the magnetically active core of the ignition coil is extrusion-coated with plastic, and the component produced in this manner is then inserted in a first coil shell, the coil shell preferably forming the secondary coil. Once additional components have been installed in the housing of the rod-type ignition coil, this component is then filled up with cast resin. Due to the extrusion-coating of the core with plastic, it is possible to avoid the use of an otherwise required shrink tube or similar tube, which protects against voltage sparkovers between the secondary coil and the core due to tears in response to thermo-mechanical stressing.

Furthermore, it is known from German Patent Application No. DE 102 47 411 to form a primary winding as an integral component of the housing, so that a separate primary coil shell is not required. Such a configuration allows a very compact design of the ignition coil.

### SUMMARY OF THE INVENTION

The ignition coil for an internal combustion engine according to the present invention has the advantage that it dispenses with a coil shell required for winding a wire, and thus has an especially compact design.

Furthermore, there is no longer a need for a fill or casting medium between the core and the coil, which minimizes the tendency to tear under thermo-mechanical loading.

### BRIEF DESCRIPTION OF THE DRAWINGS

FIG. 1 shows a longitudinal section through an ignition coil according to the present invention.

FIG. 2 shows a section in the plane II-II of FIG. 1.

FIG. 3 shows an extrusion-coated coil core in longitudinal section.

FIG. 4 shows a section in the plane IV-IV of FIG. 3.

### DETAILED DESCRIPTION

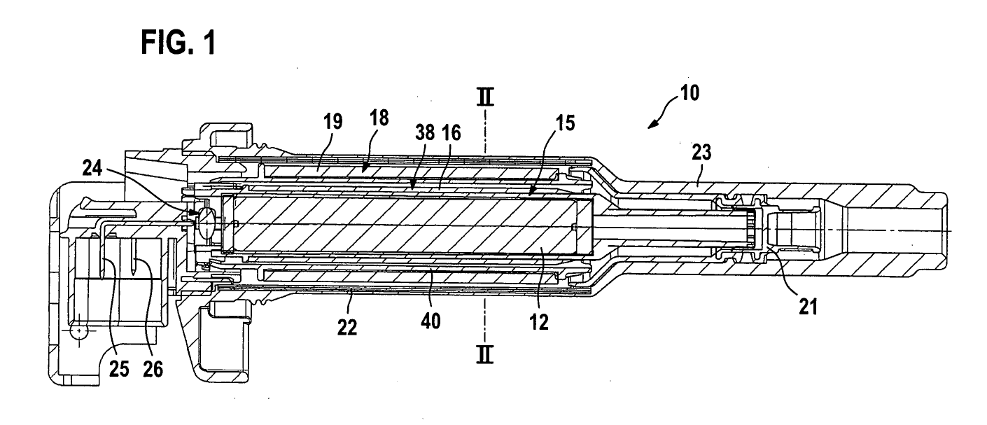

Ignition coil 10 shown in FIG. 1 is designed as a so-called rod-type ignition coil and is used for the direct contacting of a spark plug (not shown further) of an internal combustion engine. Ignition coil 10 has a magnetically active core 12 which, in the conventional manner, is made up of, for instance, a multitude of rectangular tin strips 13 that have different widths, however, in order to achieve an essentially circular cross-sectional area (FIG. 4).

Arranged concentrically about core 12 is a secondary coil 15 having a secondary winding 16, and a primary coil 18 having a primary winding 19. Secondary winding 16, which carries high voltage, is coupled to a sleeve-type contacting element 21, which accommodates the head of the spark plug. Contacting element 21 and primary coil 18 are situated inside an ignition coil housing 23, which defines the outer form of ignition coil 10. In addition, a longitudinally slotted, sleeve-type magnetic yoke element 22 is situated inside ignition-coil housing 23. Disposed inside ignition-coil housing 23, on the side of primary coil 18 lying opposite from contacting element 21, is an electric circuit 24 coupled to primary winding 19. Electric circuit 24 is coupled to the on-board voltage of the motor vehicle via connector plugs 25, 26. An ignition coil 10 described so far as well as its method of functioning are already known in general and are therefore not elucidated further.

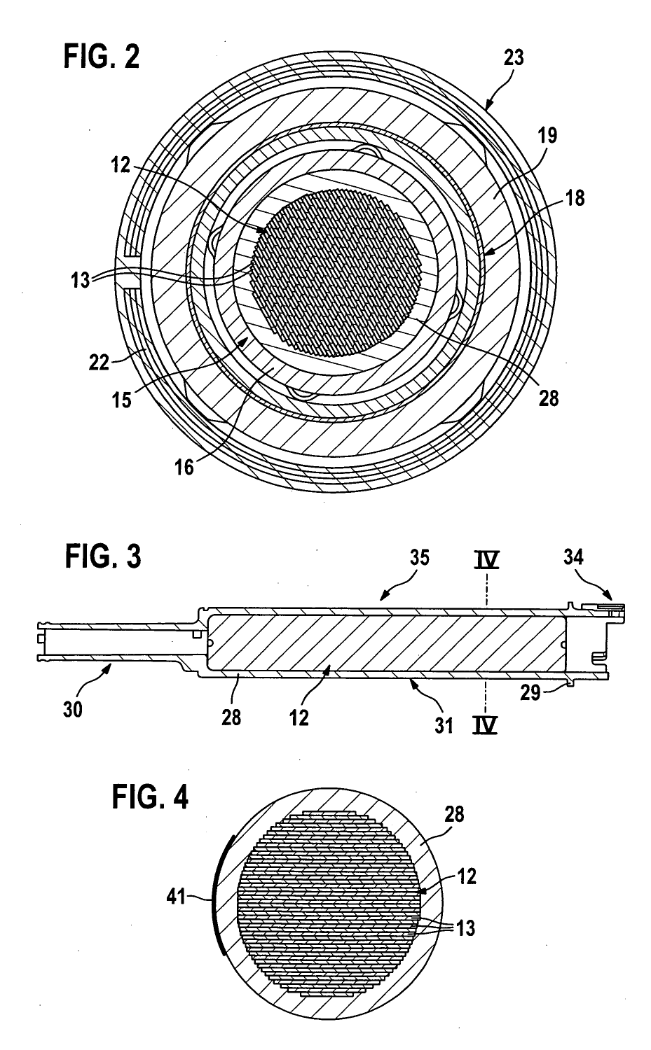

Important to the present invention is the design of core 12 or secondary coil 15 enclosing core 12. As can be gathered from an overall view of FIGS. 2 through 4, core 12 is extrusion-coated with plastic at its outer peripheral surface, which, for one, compensates for the non-uniform geometry of core 12 due to the different widths of sheet strips 13 and, for another, forms a circular cross-sectional form at the periphery. This plastic extrusion coat 28 is provided at least on the periphery of core 12. Plastic extrusion coat 28 is preferably made of a thermoplast, specifically PET, PPS or PPE. As can be gathered from FIG. 3, in particular, plastic extrusion coat 28 is extended beyond the region of the longitudinal extension of core 12.

For instance, a first region 30 can be seen, which has a smaller diameter than the region of core 11, onto which contacting element 21 may be placed. To guide secondary winding 16, ramps, guide grooves or similar devices may be situated in the transition area between cylindrical center region 31 where core 12 is situated, and region 30. A contacting region 34 is provided on the side of center region 31 lying opposite region 30, the contact region being provided for the contacting of secondary winding 16 by current bars (not shown further). Furthermore, a radially circumferential separation bar 29 is visible between center region 31 and contacting region 34.

Important to the present invention is that plastic extrusion coat 28 forms a coil body 35, which encloses a core 12, onto which secondary winding 16 is directly wound. As a result, plastic extrusion coat 28 sits between core 12 and secondary winding 16 as single separating element. During the further assembly of ignition coil 10 this unit 38, which is made up of core 12, plastic extrusion coat 28 and secondary winding 16, may subsequently be placed within primary coil 18.

It is preferably provided that primary coil 18 is made up of a primary coil shell 40 and primary winding 19, the inner diameter of primary coil shell 40 allowing module 38 to be accommodated with radial play. Module 38 situated inside primary coil 18 may then be inserted in ignition coil housing 23. Following additional fitting or installation of the electrical connections of ignition coil 10, the interior of ignition coil housing 23 is finally filled up with a plastic mass.

However, once again it is also conceivable to directly extrusion-coat module 38 with plastic in order to wind primary winding 19 onto the periphery of the module thus produced. To improve the electrical insulation characteristics, it may be required that the periphery of module 38 first be extrusion-coated with a relatively thin-flowing plastic mass so as to fill up at least the outer interspaces of secondary winding 16 before the final outer shape for the winding of primary winding 19 is formed in a second injection-molding operation, preferably using a thermoplast.

Furthermore, it is pointed out that an additional damping layer 41 may be disposed both between plastic extrusion coat 28 and secondary winding 16, and between the latter plastic extrusion coat, which forms the outer shape for winding primary winding 19, and primary winding 19. This damping layer 41, which is merely sketched in FIG. 4, is preferably made of silicon and is likewise applied with the aid of an injection-molding process. Such a damping layer 41 provides better thermo-mechanical characteristics of ignition coil 10 and is previously known as such.

What is claimed is:

1. An ignition coil for an internal combustion engine, comprising:
a magnetically active core having a plastic extrusion coat on its periphery;
a first coil concentrically surrounding the core and having a first winding and a first coil brace onto which the first winding is wound;
a second coil having a second winding and a second coil brace; and
an ignition coil housing,
wherein the first winding of at least the first coil is wound onto a periphery of the extrusion-coated core, so that the plastic extrusion coat of the core acts as a coil brace.

2. The ignition coil according to claim 1, wherein the core is rod-like.

3. The ignition coil according to claim 1, further comprising a damping layer situated between the plastic extrusion coat and the first winding.

4. The ignition coil according to claim 3, wherein the damping layer is made of silicon and is applied onto the plastic extrusion coat with the aid of an injection-molding operation.

5. The ignition coil according to claim 1, wherein the plastic extrusion coat of the core is made of a thermoplast, including at least one of PET, PPS and PPE.

6. The ignition coil according to claim 1, wherein the plastic extrusion coat extends beyond a longitudinal extension of the core.

7. The ignition coil according to claim 6, wherein extended regions of the plastic extrusion coat have a contacting region for the first winding and a section that has a smaller diameter than a region in which the core is situated.

8. The ignition coil according to claim 1, wherein the first winding of the first coil has an additional plastic extrusion coat, and a module formed in this manner acts as a coil brace for the second coil, so that the second winding of the second coil is wound onto the additional plastic extrusion coat.
